(19) United States
(12) Patent Application Publication
(10) Pub. No.: US 2005/0057792 A1
(43) Pub. Date: Mar. 17, 2005

(54) Method of forming a micromechanical structure

(76) Inventors: Shen-Ping Wang, Keelung (TW); Ching-Heng Po, Miaoli (TW); Yuh-Hwa Chang, Taipei (TW)

Correspondence Address: BIRCH STEWART KOLASCH & BIRCH, PO BOX 747, FALLS CHURCH, VA, 22040-0747, US

(21) Appl. No.: 10/660,626

(22) Filed: Sep. 12, 2003

(51) Int. Cl. G02B 26/00

(52) U.S. Cl. 359/290

(57) ABSTRACT

A method of forming a micromechanical structure. A first sacrificial silicon layer is formed on a substrate. A mirror plate is formed on part of the first sacrificial silicon layer. Argon sputtering is performed on the mirror plate and the first sacrificial silicon layer. A hydrogen treatment is performed on the first sacrificial silicon layer to form an H-treated silicon surface thereon. A second sacrificial silicon layer is formed over the mirror plate and the first sacrificial silicon layer. At least one hole is formed to penetrate the second sacrificial silicon layer, the mirror plate and the first sacrificial silicon layer. A conductive material fills in the hole to define a mirror support structure attached to the mirror plate and the substrate. The first and second sacrificial layers are removed to release the mirror plate.

### BACKGROUND OF THE INVENTION

1. Field of the Invention

The present invention relates to a method of forming a micromechanical structure, and more particularly, to a method of preventing peeling between sacrificial silicon layers in the microelectromechanical structure (MEMS) process.

2. Description of the Related Art

The use of silane (SiH₄) as a main reaction gas to deposit sacrificial silicon layers is a common step in the manufacture of semiconductor devices and MEMS. MEMS have found applications in inertial measurement, pressure sensing, thermal measurement, micro-fluidics, optics, and radio frequency communications, and the range of applications for these structures continues to grow. One example of such a structure is a reflective spatial light modulator, which is a device consisting of a planar array of electrostatically deflectable mirrors, each microscopic in size. The device is used as a micro-display system for high resolution and large screen projection. The sacrificial silicon layer in such a device is the layer over which the mirror material is deposited. Once the mirror structure is formed, the sacrificial silicon layer is removed to leave gaps below the mirrors and microhinge along one edge of each mirror to join the mirror to the remainder of the structure. The gap and the microhinge provide the mirror with the freedom of movement needed for its deflection. Devices of this type are described in, for example, U.S. Pat. Nos. 6,356,378, 6,396,619 and 6,529,310.

The success of a manufacturing procedure for structures involving sacrificial silicon layers depends on the interface adhesion therebetween. The thickness and lateral dimensions of the layers, and in the case of the deflectable mirror structures, the width of the gap and the integrity of the microhinges, are all critical to achieve uniform microstructure properties and a high yield of defect-free product. One of the critical factors is the interface quality between the sacrificial silicon layers. Performance, uniformity and yield can all be improved with increases in the interface adhesion between the sacrificial silicon layers. Hereinafter, parts of a traditional micromirror structure process will be described, with reference to FIGS. 1A and 1B.

In FIG. 1A, a light transmissive glass substrate 100 is provided. A first sacrificial silicon layer 110 is deposited on the substrate 100. The first sacrificial silicon layer 110 is an amorphous silicon or crystalline silicon layer. A mirror plate 120 is then defined on part of the first sacrificial silicon layer 110. The mirror plate 120 can be a metal plate.

Referring to FIG. 1A, unwanted remnants from the fabrication of the mirror plate 120, argon (Ar) plasma cleaning (or sputtering) 130 is then performed to remove the unwanted byproducts. Though effective, the Ar plasma cleaning 130 leaves remnant silicon dangling bonds on the surface of the first sacrificial silicon layer 110 exposing it to environmental and atmospheric impurities. The impurities attach to the silicon dangling bonds on the surface of the first sacrificial silicon layer 110 again.

In FIG. 1B, a second sacrificial silicon layer 140 is deposited on the mirror plate 120 and the first sacrificial silicon layer 110. The second sacrificial silicon layer 110 is an amorphous silicon or crystalline silicon layer. It should be noted that, since the surface of the first sacrificial silicon layer 110 has impurities, robust covalent (Si—Si) bonds at the interface between the first and second sacrificial silicon layers 110 and 140 cannot be thoroughly formed. That is, peeling 150 frequently occurs between the sacrificial silicon layers 110 and 140 after depositing the second sacrificial silicon layer 140. The peelings 150 cause the surface 141 on the second sacrificial silicon layer 140 to be rough, thereby affecting the subsequent photolithography and etching. In addition, the peeling issue will worsen with subsequent repeated following thermal processes, thereby generating particles which contaminate other processing tools.

In U.S. Pat. No. 5,835,256, Huibers et al disclose a deflectable spatial light modulator (SLM). The method describes formation of silicon nitride or silicon dioxide mirror elements and the underlying polysilicon sacrificial layer serving as a support to be removed in subsequent etching. Nevertheless, the method does not eliminate the peeling issue in the sacrificial silicon layer.

In U.S. Pat. No. 6,396,619, Huibers et al disclose a deflectable spatial light modulator (SLM). The sacrificial material layer can be silicon or polymer. Nevertheless, the method does not teach how to solve the peeling issue of the sacrificial silicon layer.

In U.S. Pat. No. 6,290,864, Patel et al disclose a procedure of etching sacrificial silicon layers for the manufacture of MEMS. The method, utilizing noble gas fluorides or halogen fluorides as etchant gases, exhibits greater selectivity toward the silicon portion relative to other portions of the microstructure by incorporating non-etchant gaseous additives in the etchant gas. Nevertheless, this method does not eliminate peeling in the sacrificial silicon layer.

### SUMMARY OF THE INVENTION

The object of the present invention is to provide a method of forming a micromechanical structure.

Another object of the present invention is to provide a method of preventing peeling between sacrificial silicon layers in a MEMS process.

Yet another object of the present invention is to provide a method of forming a micromirror structure.

In order to achieve these objects, the present invention provides a method of preventing peeling between two silicon layers. A first layer having a first silicon material is provided. By performing a hydrogen treatment on the first layer, an H-treated silicon surface with Si—H bonds is formed on the first layer. A second layer having a second silicon material is formed on the H-treated silicon surface.

The present invention also provides a method of forming a micromirror structure. A first sacrificial silicon layer is formed on a substrate. A mirror plate is formed on part of the first sacrificial silicon layer and byproducts are created. An inert gas sputtering is performed on the mirror plate and the first sacrificial silicon layer to remove the byproducts. A hydrogen treatment is performed on the first sacrificial silicon layer to form an H-treated silicon surface thereon. A second sacrificial silicon layer is formed over the mirror plate and the first sacrificial silicon layer. At least one hole is formed to penetrate the second sacrificial silicon layer, the mirror plate and the first sacrificial silicon layer. The hole is filled with a conductive material to define a mirror support structure attached to the mirror plate and the substrate. The first and second sacrificial layers are removed to release the mirror plate.

The present invention also provides another method of forming a micromirror structure. A first sacrificial silicon layer is formed on a substrate. A mirror plate is formed on part of the first sacrificial layer and byproducts are created. Inert gas sputtering is performed on the mirror plate and the first sacrificial silicon layer to remove the byproducts. A hydrogen treatment is performed on the first sacrificial silicon layer to form an H-treated silicon surface thereon. A second sacrificial silicon layer is formed over the first sacrificial layer and the mirror plate. The first and second sacrificial silicon layers are partially etched to create an opening exposing a portion of the mirror plate and at least one hole exposing a portion of the substrate. The opening and the hole are filled with a conductive material to define a mirror support structure attached to the mirror plate and the substrate. The first and second sacrificial silicon layers are removed to release the mirror plate.

The present invention improves on the background art in that the first sacrificial silicon layer is performed by a hydrogen treatment to form an H-treated silicon surface thereon. Thus, the second sacrificial silicon layer can be securely deposited on the first sacrificial silicon layer without peeling, thereby increasing manufacturing yield and ameliorating the disadvantages of the background art.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention can be more fully understood by reading the subsequent detailed description in conjunction with the examples and references made to the accompanying drawings which are given by way of illustration only, and thus are not limitative of the present invention, and wherein:

FIGS. 1A and 1B are cross-sectional views, according to parts of a traditional micromirror structure process;

FIGS. 2A˜2F are cross-sectional views, according to one method of manufacturing a MEMS device of the present invention; and

FIGS. 3A˜3F illustrate perspective views of a portion of a substrate, according to another method of manufacturing a MEMS device of the present invention.

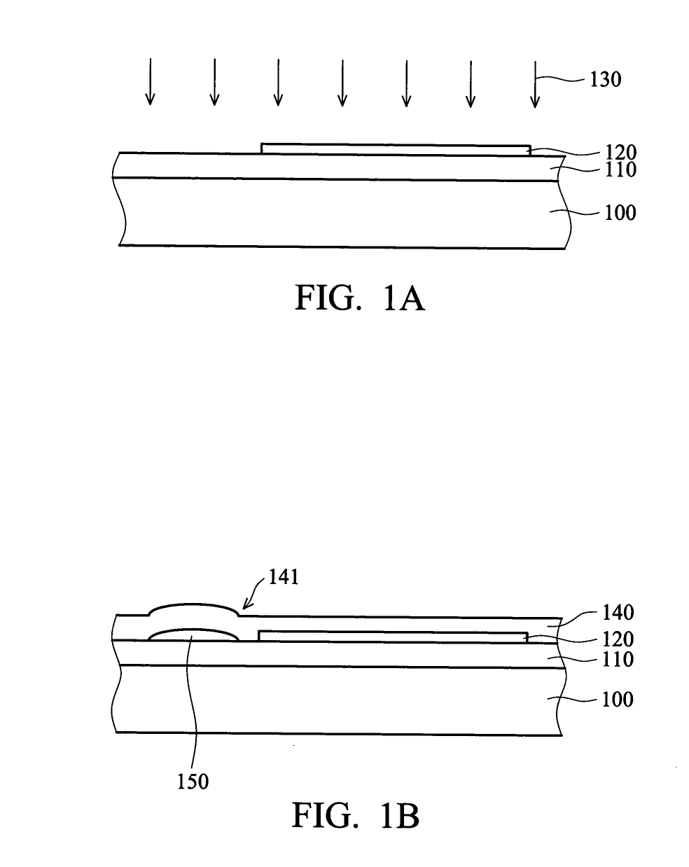

### DETAILED DESCRIPTION OF THE INVENTION

A silicon process proposed by this invention, used to preventing peeling between two (lower and upper) sacrificial silicon layers in the fabrication of MEMS, comprises a hydrogen treatment performed on a lower sacrificial silicon layer to form an H-treated silicon surface thereon. By means of the H-treated silicon surface, the upper sacrificial silicon layer can be securely deposited on the lower sacrificial silicon layer without peeling. The lower sacrificial silicon layer can be an amorphous silicon or crystalline silicon layer. The upper sacrificial silicon layer can be amorphous or crystalline silicon. In one example, the hydrogen treatment is a hydrogen (H) plasma treatment. In another example, the hydrogen treatment is a HF (Hydrofluoric Acid) vapor treatment. When the hydrogen plasma treatment is employed, the operational conditions of the hydrogen plasma treatment comprise an RF power of 50˜300 Watts, a hydrogen gas flow of 200˜2000 sccm, an operating temperature of 300˜400° C., an operating time of 30˜90 sec and an operating pressure of 0.1˜10 torr. Preferably, the operational conditions of the hydrogen plasma treatment comprise a RF power of 200 Watts, a hydrogen gas flow of 600 sccm, an operating temperature of 320° C., an operating time of 60 sec and an operating pressure of 0.8 torr. In addition, the hydrogen plasma treatment and the deposition of the upper sacrificial silicon layer can be preformed in the same processing chamber. When the HF vapor treatment is employed, the HF vapor uses HF (49 wt %) with a ratio of H₂O: HF=30:1˜70:1 and an operating time of 60 sec or less. Preferably, the HF vapor uses HF (49 wt %) with a ratio of H₂O: HF=50:1.

The inventors find hydrogen ions are more absorptive of Si atoms than other environmental and atmospheric impurities such as N and O ions. That is, the hydrogen treatment substitutes Si—H bonds for Si dangling bonds on the surface of the lower sacrificial silicon layer before depositing the upper sacrificial silicon layer. Thus, the dangling Si bonds are resistant to atmospheric impurities, and have improved impurity absorption resistance on the interface of the lower sacrificial silicon layer. Since the reaction gas for depositing silicon is silane (SiH₄), the above Si—H bonds can be replaced with strong covalent Si—Si bonds during deposition (i.e. CVD). Therefore, the upper sacrificial silicon layer can be securely deposited on the lower sacrificial silicon layer without peeling.

The inventor provides experimental results. The lower sacrificial silicon layer with H-treated silicon surface is disposed in the atmosphere for 12 hours, and the upper sacrificial silicon layer also can be securely deposited on the lower sacrificial silicon layer without peeling. A sample, performed with a heat-treatment at 400° C., comprising the lower sacrificial silicon layer with H-treated silicon surface and the upper sacrificial silicon layer resulted in no peeling.

Accordingly, it has been verified that the additional hydrogen treatment can improve the interface adhesion between the lower and upper sacrificial silicon layers. In addition, the hydrogen treatment and the deposition of sacrificial silicon layer can be performed in the same processing chamber, or with the same equipment.

The present method is well suited for the MEMS process. A wide variety of MEMS devices can be made in accordance with the present invention, including microsensors, microvalves, micromirrors for optical scanning, microscopy, spectroscopy, maskless lithography, projection displays and optical switching, etc. The examples demonstrated below are micromirrors; however any of these or other MEMS devices can be made in accordance with the methods and materials of the present invention.

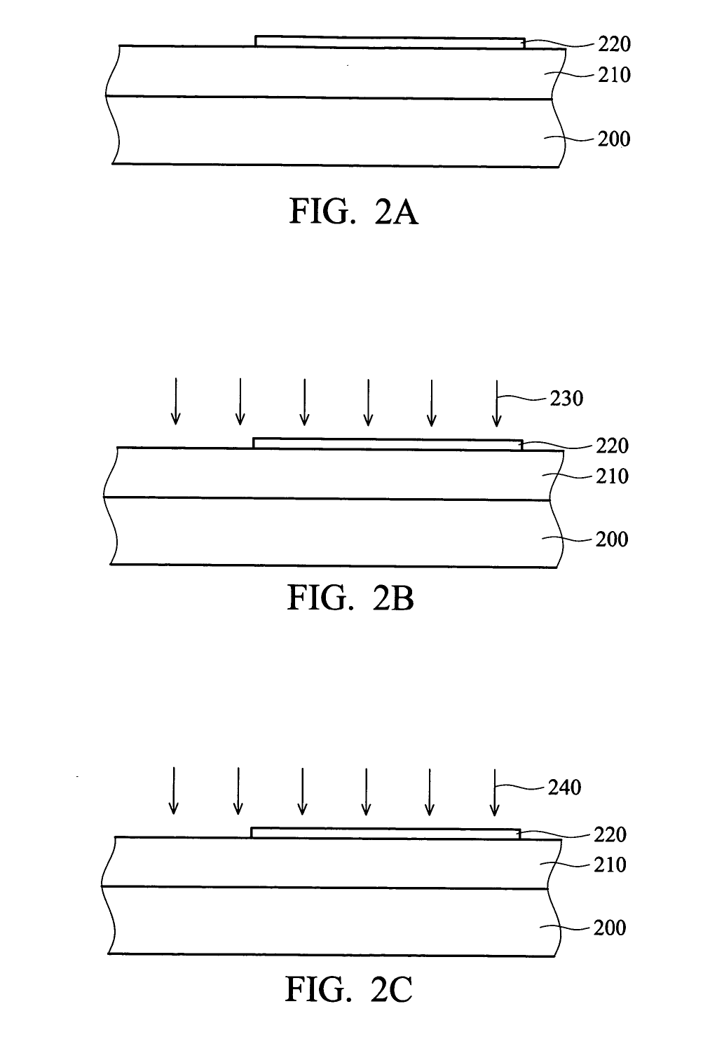

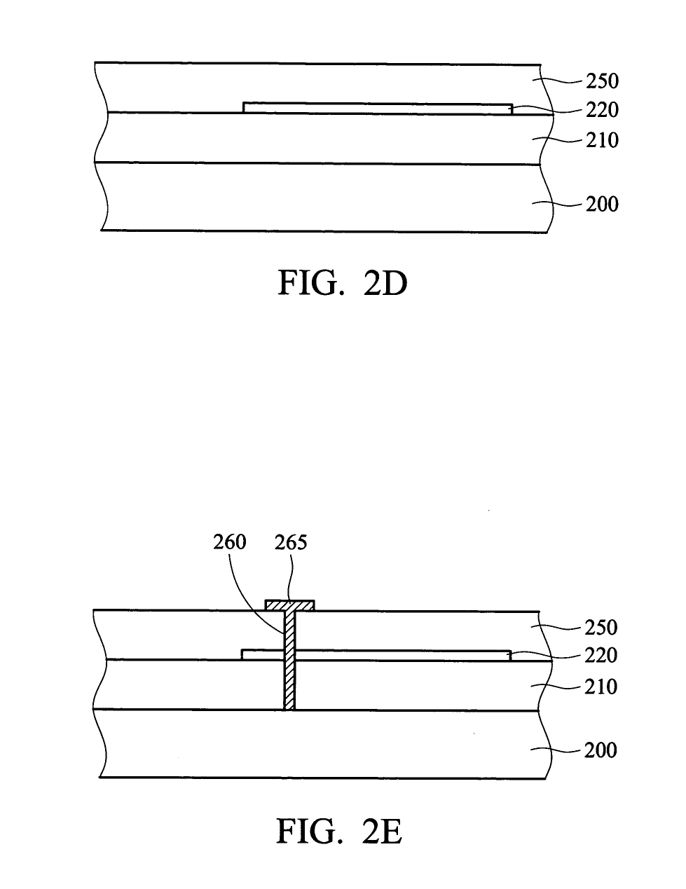

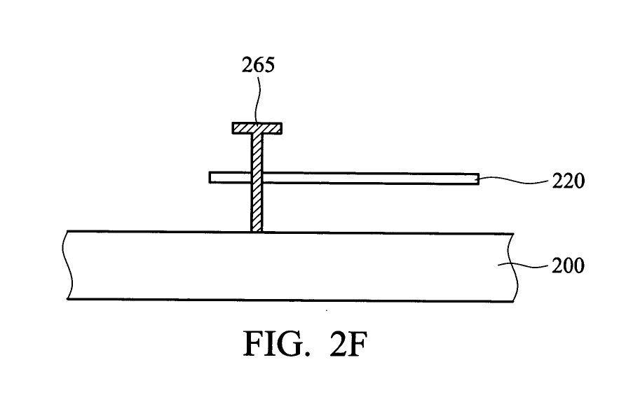

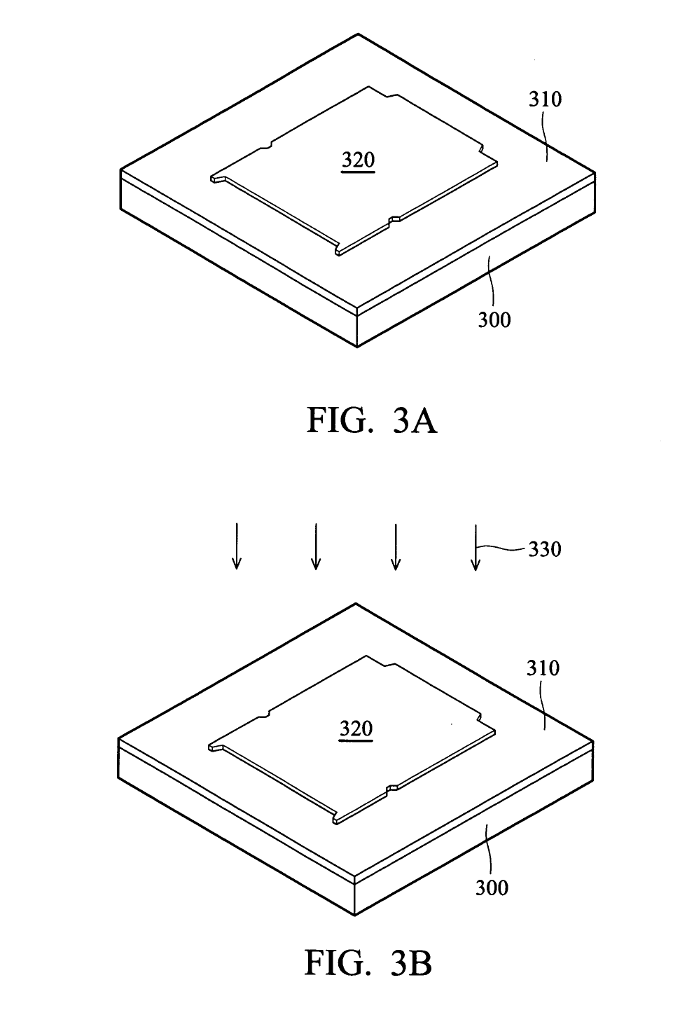

FIGS. 2A˜2F are cross-sectional views of one method of manufacturing a MEMS device according to the present invention.

In FIG. 2A, a substrate 200 is provided. The substrate 200 is a light transmissive substrate, such as a glass or quartz substrate. A first sacrificial silicon layer 210 is formed on the substrate 200. The first sacrificial silicon layer 210 is amorphous silicon or crystalline silicon deposited by plasma enhanced chemical vapor deposition (PECVD) or sputtering (physical vapor deposition of PVD). The thickness of the first sacrificial silicon layer 210 can be 5000˜20000 Å. The amorphous silicon can additionally be annealed to increase stability.

In FIG. 2A, a mirror plate 220 is formed on the first sacrificial silicon layer 210. The mirror plate 220 can be a multilayer metal plate comprising an OMO (oxide-metal-oxide) structure. The metal can be Al, AlCu, AlSiCu and/or Ti formed by sputtering and patterning. The oxide can be SiO₂ formed by CVD. In this example, the mirror plate 220 is a reflective element deflectably coupled to the substrate 200. It should be noted that, in a typical SLM implementation in accordance with the present invention, an entire array of micromirrors is fabricated at the same time. For simplicity, formation of other mirror plates on the substrate 200 is not illustrated.

Referring to FIG. 2B, unwanted remnants (or called byproducts) generated by the fabrication of the mirror plate 220, are removed from the mirror plate 220 and the first sacrificial silicon layer 210 by an inert gas (e.g. Ar) plasma cleaning (or sputtering) procedure 230. Though effective, the Ar sputtering 230 leaves remnant silicon dangling bonds on the surface of the first sacrificial silicon layer 210 exposing it to environmental and atmospheric impurities.

In FIG. 2C, a hydrogen treatment 240 is performed on the first sacrificial silicon layer 210 to form an H-treated silicon surface 245 thereon. The H-treated silicon surface 245 has Si—H bonds that substitute for the Si dangling bonds, thereby improving the impurity absorption resistance on the interface of the first sacrificial silicon layer 210.

A demonstrative example of the hydrogen treatment 240 is herein described, but is not intended to limit the present invention. In one example, the hydrogen treatment is a hydrogen (H) plasma treatment. In another example, the hydrogen treatment is a HF (Hydrofluoric Acid) vapor treatment. When the hydrogen plasma treatment is employed, the operational conditions of the hydrogen plasma treatment comprise an RF power of 50˜300 Watts, a hydrogen gas flow of 200˜2000 sccm, an operating temperature of 300˜400° C., an operating time of 30˜90 sec and an operating pressure of 0.1˜10 torr. Preferably, the operational conditions of the hydrogen plasma treatment comprise an RF power of 200 Watts, a hydrogen gas flow of 600 sccm, an operating temperature of 320° C., an operating time of 60 sec and an operating pressure of 0.8 torr. More preferably, the hydrogen plasma treatment 240 and the deposition of the second sacrificial silicon layer 250 (shown in FIG. 2D) are preformed in the same processing chamber. When the HF vapor treatment is employed, the HF vapor uses HF (49 wt %) with a ratio of H₂O: HF=30:1˜70:1 and an operating time of 60 sec or less. Preferably, the HF vapor uses HF (49 wt %) with a ratio of H₂O: HF=50:1.

In FIG. 2D, a second sacrificial silicon layer 250 is formed on the H-treated surface 245 of the first sacrificial silicon layer 210 and the mirror plate 220. The second sacrificial silicon layer 250 is amorphous silicon or crystalline silicon deposited by plasma enhanced chemical vapor deposition (PECVD). The thickness of the second sacrificial silicon layer 250 can be 2000˜5000 Å. The amorphous silicon can additionally be annealed to increase stability. In this embodiment, the reaction gas for depositing the second sacrificial silicon layer 250 is silane (SiH₄). The carrier gas can be Ar, He, H₂ or N₂. The above Si—H bonds are replaced with strong covalent Si—Si bonds during this deposition. Therefore, the second sacrificial silicon layer 250 can be securely deposited on the first sacrificial silicon layer 210 without peeling.

In FIG. 2E, at least one hole 260 is formed to penetrate the second sacrificial silicon layer 250, the mirror plate 220 and the first sacrificial silicon layer 210. Then, a conductive material is deposited in the hole 260 to form a plug 265 serving as a mirror support structure 265 to attach the mirror plate 220 and the substrate 200. The conductive material is, for example, W, Mo, Ti, Ta or a conductive metal compound. For some plug materials, it may be desirable to first deposit a linear (not shown) in order to avoid peeling (e.g., for a tungsten plug, a TiN, TiW or TiWN linear can be deposited to surround the tungsten in the hole in the sacrificial layers and subsequent to release of the sacrificial layers). It should be noted that, after the thermal processes for depositing the linear and the plug, there is no peeling between the first and second sacrificial silicon layers 210 and 250.

In FIG. 2F, the first and second sacrificial silicon layers 210 and 250 are removed to release the mirror plate 220. Thus, a mirror structure is obtained.

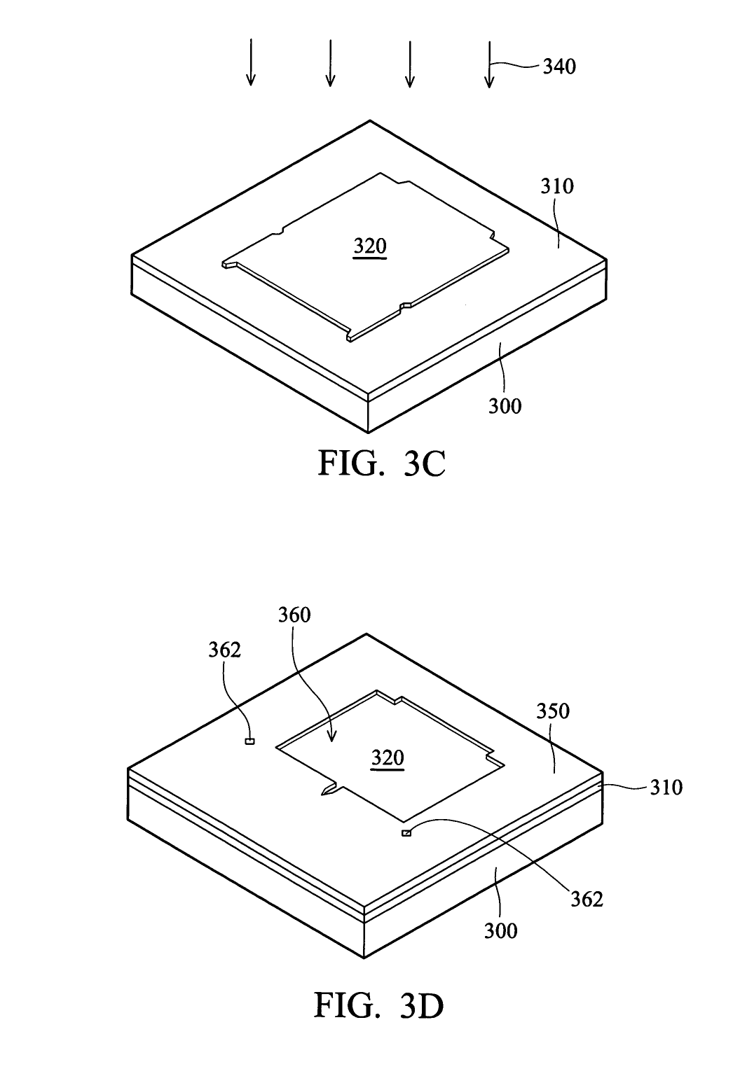

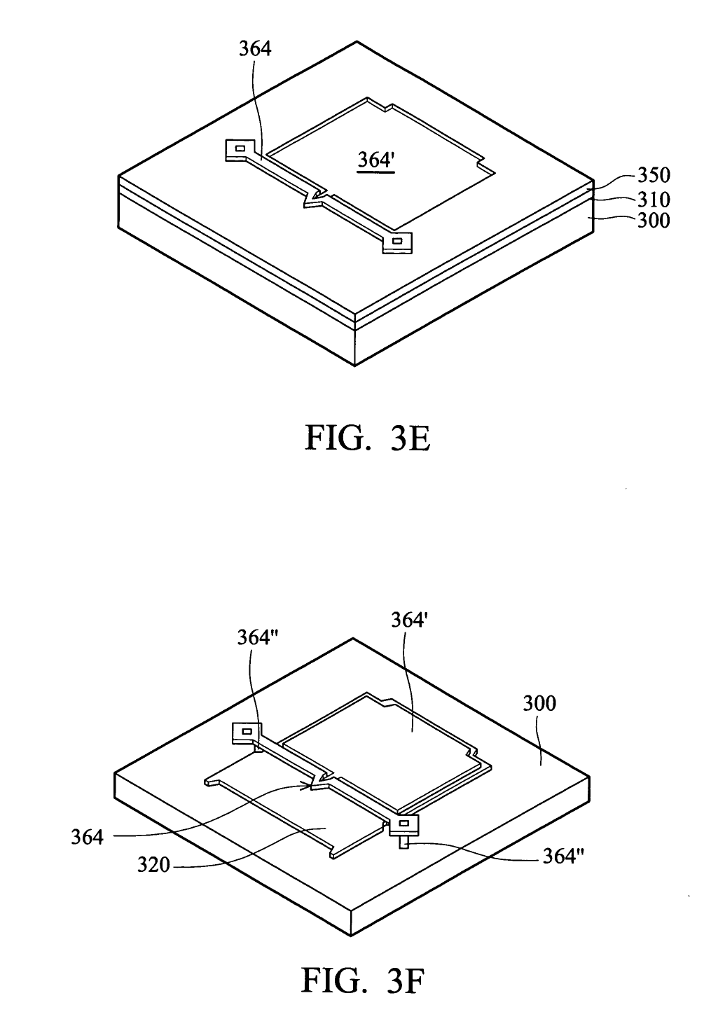

FIGS. 3A˜3F illustrate perspective views of a portion of a substrate, according to another method of manufacturing a MEMS device of the present invention.

In FIG. 3A, a substrate 300 is provided. The substrate 300 is a light transmissive substrate, such as a glass or quartz substrate. A first sacrificial silicon layer 310 is formed on the substrate 300. The first sacrificial silicon layer 310 is amorphous silicon or crystalline silicon deposited by plasma enhanced chemical vapor deposition (PECVD) or sputtering (physical vapor deposition of PVD). The thickness of the first sacrificial silicon layer 310 can be 5000˜20000 Å. The amorphous silicon can additionally be annealed to increase stability.

In FIG. 3A, a mirror plate 320 is formed on the first sacrificial silicon layer 310. The mirror plate 320 can be a multilayer metal plate comprising an OMO (oxide-metal-oxide) structure. The metal can be Al, AlCu, AlSiCu and/or Ti formed by sputtering and patterning. The oxide can be SiO₂ formed by CVD. In this example, the mirror plate 320 is a reflective element deflectably coupled to the substrate 300. It should be noted that, in a typical SLM implementation in accordance with the present invention, an entire array of micromirrors is fabricated at the same time. For simplicity, other mirror plates that are formed on the substrate 300 are not illustrated.

Referring to FIG. 3B, unwanted remnants (or byproducts) generated by the fabrication of the mirror plate 320, are removed from the mirror plate 320 and the first sacrificial silicon layer 310 by an inert gas (e.g. Ar) plasma cleaning (or sputtering) procedure 330. Though effective, the Ar sputtering 330 leaves remnant silicon dangling bonds on the surface of the first sacrificial silicon layer 310 exposing it to environmental and atmospheric impurities.

In FIG. 3C, a hydrogen treatment 340 is performed on the first sacrificial silicon layer 310 to form an H-treated silicon surface 345 thereon. The H-treated silicon surface 345 has Si—H bonds that substitute for the Si dangling bonds, thereby improving the impurity absorption resistance on the interface of the first sacrificial silicon layer 310.

A demonstrative example of the hydrogen treatment 340 is herein described, but is not intended to limit the present invention. In one example, the hydrogen treatment is a hydrogen (H) plasma treatment. In another example, the hydrogen treatment is a HF (Hydrofluoric Acid) vapor treatment. When the hydrogen plasma treatment is employed, the operational conditions of the hydrogen plasma treatment comprise an RF power of 50-300 Watts, a hydrogen gas flow of 200˜2000 sccm, an operating temperature of 300˜400° C., an operating time of 30˜90 sec and an operating pressure of 0.1˜10 torr. Preferably, the operational conditions of the hydrogen plasma treatment comprise an RF power of 200 Watts, a hydrogen gas flow of 600 sccm, an operating temperature of 320° C., an operating time of 60 sec and an operating pressure of 0.8 torr. More preferably, the hydrogen plasma treatment 340 and the deposition of the second sacrificial silicon layer 350 (shown in FIG. 3D) are preformed in the same processing chamber. When the HF vapor treatment is employed, the HF vapor uses HF (49 wt %) with a ratio of H₂O: HF=30:1˜70:1 and an operating time of 60 sec or less. Preferably, the HF vapor uses HF (49 wt %) with a ratio of H₂O: HF=50:1.

In FIG. 3D, a second sacrificial silicon layer 350 is formed on the first sacrificial silicon layer 310 and the mirror plate 320. The second sacrificial silicon layer 350 is amorphous silicon or crystalline silicon deposited by plasma enhanced chemical vapor deposition (PECVD). The thickness of the second sacrificial silicon layer 350 can be 2000˜5000 Å. The amorphous silicon can additionally be annealed to increase stability. In this embodiment, the reaction gas for depositing the second sacrificial silicon layer 350 is silane (SiH₄). The carrier gas can be Ar, He, H₂ or N₂. The above Si—H bonds are replaced with strong covalent Si—Si bonds during this deposition. Therefore, the second sacrificial silicon layer 350 can be securely deposited on the first sacrificial silicon layer 310 without peeling.

In FIG. 3D, the first and second sacrificial silicon layers 310 and 350 are then partially etched to create an opening 360 exposing a portion of the mirror plate 320 and at least one hole 362 exposing a portion of the surface of the substrate 300.

In FIG. 3E, a conductive material is deposited in the opening 360 and the hole 362 and is defined to form a mirror support structure 364 to attach the substrate 300. The conductive material is, for example, W, Mo, Ti, Ta or a conductive metal compound. The mirror support structure 364 as shown has an electrode portion 364′ that is attached to the mirror plate 320, and a hinge support structure 364″ (shown in FIG. 3F) attached to the substrate 300.

In FIG. 3F, the first and second sacrificial silicon layers 310 and 350 are removed to release the mirror plate 320. Thus, a mirror structure is obtained.

The resulting micromirror structure is ready to be sandwiched with a semiconductor substrate having electrodes and electronic circuitry therein to form a light valve device. The process for forming the semiconductor substrate for actuation of the micromirror structure is described in U.S. Pat. No. 5,835,256, and is therefore not discussed herein to avoid obscuring aspects of the present invention.

Thus, the present invention provides a method of preventing peeling between sacrificial silicon layers in the MEMS process. The present method uses the hydrogen treatment (e.g. the H plasma treatment) to form an H-treated surface on the lower sacrificial silicon layer before depositing the upper sacrificial silicon layer. Thus, the upper sacrificial silicon layer can be securely deposited on the lower sacrificial silicon layer without peeling, thereby increasing manufacturing yield, eliminating contamination and ameliorating the disadvantages of the background art.

Finally, while the invention has been described by way of example and in terms of the above, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

1. A method of preventing peeling between two silicon layers, comprising the steps of:
providing a first layer having a first silicon material;
performing a hydrogen treatment on the first layer; and
forming a second layer having a second silicon material on the first layer.

2. The method according to claim 1, wherein the first silicon material is amorphous silicon or crystalline silicon.

3. The method according to claim 1, wherein the second silicon material is amorphous silicon or crystalline silicon.

4. The method according to claim 1, wherein the hydrogen treatment is a hydrogen plasma treatment.

5. The method according to claim 4, wherein operational conditions of the hydrogen plasma treatment comprise an RF power of 50˜300 Watts, a hydrogen gas flow of 200˜2000 sccm, an operating temperature of 300˜400° C., an operating time of 30˜90 sec and an operating pressure of 0.1˜10 torr.

6. The method according to claim 5, wherein the operational conditions of the hydrogen plasma treatment comprise an RF power of 200 Watts, a hydrogen gas flow of 600 sccm, an operating temperature of 320° C., an operating time of 60 sec and an operating pressure of 0.8 torr.

7. The method according to claim 1, wherein the hydrogen plasma treatment is an HF vapor treatment.

8. The method according to claim 7, wherein the HF vapor uses HF (49 wt %) with a ratio of H₂O: HF=30:1˜70:1.

9. The method according to claim 4, wherein the hydrogen plasma treatment and the formation of the second layer are preformed in the same processing chamber.

10. A method of preventing peeling between two silicon layers in the microelectromechanical structure (MEMS) process, comprising the steps of:
providing a first layer having a first silicon material;
performing a hydrogen treatment on the first layer to form an H-treated silicon surface with Si—H bonds thereon; and
forming a second layer having a second silicon material on the H-treated silicon surface.

11. The method according to claim 10, wherein the first silicon material is amorphous silicon or crystalline silicon.

12. The method according to claim 10, wherein the second silicon material is amorphous silicon or crystalline silicon.

13. The method according to claim 12, wherein the second layer is formed by CVD using SiH₄ as a reaction gas.

14. The method according to claim 10, wherein the hydrogen treatment is a hydrogen plasma treatment.

15. The method according to claim 14, wherein operational conditions of the hydrogen plasma treatment comprise an RF power of 5˜300 Watts, a hydrogen gas flow of 200˜2000 sccm, an operating temperature of 300˜400° C., an operating time of 30˜90 sec and an operating pressure of 0.1˜10 torr.

16. The method according to claim 15, wherein the operational conditions of the hydrogen plasma treatment comprise an RF power of 200 Watts, a hydrogen gas flow of 600 sccm, an operating temperature of 320° C., an operating time of 60 sec and an operating pressure of 0.8 torr.

17. The method according to claim 10, wherein the hydrogen plasma treatment is an HF vapor treatment.

18. The method according to claim 17, wherein the HF vapor uses HF (49 wt %) with a ratio of H₂O: HF=30:1˜70:1.

19. The method according to claim 14, wherein the hydrogen plasma treatment and the formation of the second layer are preformed in the same processing chamber.

20. A method of forming a micromechanical structure, comprising the steps of:
providing at least one micromechanical structural layer above a substrate, the micromechanical structural layer being sustained between a lower sacrificial silicon layer having an H-treated surface and an upper sacrificial silicon layer; and
removing the upper and lower sacrificial silicon layers;
wherein the H-treated silicon surface increases interface adhesion between the lower and upper sacrificial silicon layers.

21. The method according to claim 20, wherein the lower sacrificial silicon layer is an amorphous silicon or crystalline silicon layer.

22. The method according to claim 20, wherein the upper sacrificial silicon layer is an amorphous silicon layer or a crystalline silicon layer.

23. The method according to claim 20, wherein the upper sacrificial silicon layer is formed by CVD using SiH₄ as a reaction gas.

24. The method according to claim 20, wherein the H-treated surface of the lower sacrificial silicon layer is performed by a hydrogen plasma treatment.

25. The method according to claim 24, wherein operational conditions of the hydrogen plasma treatment comprise an RF power of 50˜300 Watts, a hydrogen gas flow of 200˜2000 sccm, an operating temperature of 300˜400° C., an operating time of 30˜90 sec and an operating pressure of 0.1˜10 torr.

26. The method according to claim 25, wherein the operational conditions of the hydrogen plasma treatment comprise an RF power of 200 Watts, a hydrogen gas flow of 600 sccm, an operating temperature of 320° C., an operating time of 60 sec and an operating pressure of 0.8 torr.

27. The method according to claim 20, wherein the H-treated surface of the lower sacrificial layer is performed by an HF vapor treatment.

28. The method according to claim 27, wherein the HF vapor uses HF (49 wt %) with a ratio of H₂O: HF=30:1˜70:1.

29. The method according to claim 20, wherein the H-treated surface has Si—H bonds.

30. A method of forming a micromirror structure, comprising the steps of:
forming a first sacrificial silicon layer on a substrate;
forming a mirror plate on part of the first sacrificial silicon layer;
performing an inert gas sputtering on the mirror plate and the first sacrificial silicon layer;
performing a hydrogen treatment on the first sacrificial silicon layer to form an H-treated silicon surface thereon;
forming a second sacrificial silicon layer over the mirror plate and the first sacrificial silicon layer;
forming at least one hole penetrating the second sacrificial silicon layer, the mirror plate and the first sacrificial silicon layer;
filling a conductive material in the hole to define a mirror support structure attached to the mirror plate and the substrate; and
removing the first and second sacrificial layers to release the mirror plate.

31. The method according to claim 30, wherein the substrate is a glass or quartz substrate.

32. The method according to claim 30, wherein the first sacrificial silicon layer is an amorphous silicon layer or a crystalline silicon layer.

33. The method according to claim 30, wherein the second sacrificial silicon layer is an amorphous silicon layer or a crystalline silicon layer.

34. The method according to claim 30, wherein the second sacrificial silicon layer is formed by CVD using SiH₄ as a reaction gas.

35. The method according to claim 30, wherein the inert gas sputtering is argon sputtering.

36. The method according to claim 30, wherein the hydrogen treatment is a hydrogen plasma treatment.

37. The method according to claim 36, wherein operational conditions of the hydrogen plasma treatment comprise an RF power of 50˜300 Watts, a hydrogen gas flow of 200˜2000 sccm, an operating temperature of 300˜400° C., an operating time of 30˜90 sec and an operating pressure of 0.1˜10 torr.

38. The method according to claim 37, wherein the operational conditions of the hydrogen plasma treatment comprise an RF power of 200 Watts, a hydrogen gas flow of 600 sccm, an operating temperature of 320° C., an operating time of 60 sec and an operating pressure of 0.8 torr.

39. The method according to claim 36, wherein the hydrogen plasma treatment and the formation of the second layer are preformed in the same processing chamber.

40. The method according to claim 30, wherein the hydrogen treatment is an HF vapor treatment.

41. The method according to claim 40, wherein the HF vapor uses HF (49 wt %) with a ratio of H₂O: HF=30:1˜70:1.

42. The method according to claim 30, wherein the mirror plate is an OMO (oxide-metal-oxide) layer.

43. The method according to claim 30, wherein the conductive material comprises at least one of W, Mo, Ti and Ta.

44. A method for forming a micromirror structure, comprising the steps of:
forming a first sacrificial silicon layer on a substrate;
forming a mirror plate on part of the first sacrificial layer;
performing an inert gas sputtering on the mirror plate and the first sacrificial silicon layer;
performing a hydrogen treatment on the first sacrificial silicon layer to form an H-treated silicon surface thereon;
forming a second sacrificial silicon layer over the first sacrificial layer and the mirror plate;
partially etching the first and second sacrificial silicon layers to create an opening exposing a portion of the mirror plate and at least one hole exposing a portion of the substrate;
filling a conductive material in the opening and the hole to define a mirror support structure attached to the mirror plate and the substrate; and
removing the first and second sacrificial silicon layers to release the mirror plate.

45. The method according to claim 44, wherein the substrate is a glass or quartz substrate.

46. The method according to claim 44, wherein the first sacrificial silicon layer is an amorphous silicon layer or a crystalline silicon layer.

47. The method according to claim 44, wherein the second sacrificial silicon layer is an amorphous silicon layer or a crystalline silicon layer.

48. The method according to claim 44, wherein the second sacrificial silicon layer is formed by CVD using SiH₄ as a reaction gas.

49. The method according to claim 44, wherein the inert gas sputtering is argon sputtering.

50. The method according to claim 44, wherein the hydrogen treatment is a hydrogen plasma treatment.

51. The method according to claim 50, wherein operational conditions of the hydrogen plasma treatment comprise an RF power of 50˜300 Watts, a hydrogen gas flow of 200˜2000 sccm, an operating temperature of 300˜400° C., an operating time of 30˜90 sec and an operating pressure of 0.1˜10 torr.

52. The method according to claim 51, wherein the operational conditions of the hydrogen plasma treatment comprise an RF power of 200 Watts, a hydrogen gas flow of 600 sccm, an operating temperature of 320° C., an operating time of 60 sec and an operating pressure of 0.8 torr.

53. The method according to claim 50, wherein the hydrogen plasma treatment and the formation of the second layer are preformed in the same processing chamber.

54. The method according to claim 44, wherein the hydrogen treatment is an HF vapor treatment.

55. The method according to claim 54, wherein the HF vapor uses HF (49 wt %) with a ratio of H₂O: HF=30:1˜70:1.

56. The method according to claim 44, wherein the mirror plate is an OMO (oxide-metal-oxide) layer.

57. The method according to claim 44, wherein the conductive material comprises at least one of W, Mo, Ti and Ta.
